(19) United States
(12) Patent Application Publication
(10) Pub. No.: US 2008/0055450 A1
(43) Pub. Date: Mar. 6, 2008

(54) Multi-plate solid-state imager module and apparatus

(75) Inventor: Tetsu Wada, Miyagi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM Corporation, Tokyo (JP)

(21) Appl. No.: 11/709,190

(22) Filed: Feb. 22, 2007

(30) Foreign Application Priority Data
Mar. 3, 2006 (JP) P2006-058198

(51) Int. Cl. H04N 5/335

(52) U.S. Cl. 348/311; 348/E05.091

(57) ABSTRACT

A multi-plate solid-state imaging element module comprising a plurality of solid-state imaging devices identical in structure, each comprising a set of pixels, wherein said plurality of solid-state imaging devices are arranged so that the sets of pixels of said plurality of solid-state imaging devices are effectively deviated to each other, so as to effectively arrange all the pixels of the plurality of solid-state imaging devices in a checkered form.

### BACKGROUND OF THE INVENTION

1. Field of the Invention

The present invention relates to a multi-plate solid-state imaging element module and apparatus having, say, four solid-state imaging devices arranged deviated at pixels, and more particularly to a multi-plate solid-state imaging element module and apparatus realized a high resolution.

2. Description of the Related Art

Four-plate type solid-state imaging apparatus are described, say, in JP-A-7-250332 and JP-A-60-154781 noted in the below. In the four-plate type, resolution can be improved by arranging the solid-state imaging devices with deviation at pixels. This fact is explained with reference to FIGS. 6 and 7.

FIGS. 6A, 6B, 6C and 6D respectively show solid-state imaging devices 1, 2, 3, 4 that are identical in structure. The solid-state imaging devices 1, 2, 3, 4 are each arranged with pixels (each represented by a “circle” put therein with a solid-state imaging device number to which the relevant pixel belongs, in the figure), wherein pixel pitch and size (opening) are equal between the solid-state imaging devices 1, 2, 3, 4.

Relatively to the arrangement position of the solid-state imaging device 1, the solid-state imaging device 2 is arranged deviated a half pixel pitch in both x (horizontal) and y (vertical) directions, the solid-state imaging device 3 is arranged deviated a half pixel pitch in the y direction, and the solid-state imaging device 4 is arranged deviated a half pixel pitch in the x direction. Due to this, the solid-state imaging devices 1, 2, 3, 4 have pixels arranged in positions shown in FIG. 7. Namely, it can be understood that the four-plate solid-state imaging apparatus is effectively given a resolution four times greater.

FIG. 8 is a pixel arrangement diagram where the solid-state imaging devices 1 and 2 are arranged with deviation at pixels so that the real pixels thereof are effectively arranged in a checkered form. Where the pixels are in a checkered arrangement (honeycomb arrangement), the data at an imaginary pixel, shown at a dotted-lined circle; is determined by an interpolation with the image data of the surrounding real pixels 1, 2, thereby making the image data in a tetragonal lattice form.

Namely, the two-plate solid state imaging apparatus having FIG. 8 devices 1, 2 provides an image having a resolution equal to the resolution of an image obtained by the FIG. 7 four-plate solid-state imaging apparatus. Even in case the solid-state imaging devices to mount are increased to four from two in the number, the resolution is not improved.

### SUMMARY OF THE INVENTION

It is an object of the present invention to provide a multi-plate solid-state imaging device, module and apparatus.

A multi-plate solid-state imaging element module according to the present invention is a multi-plate solid-state imaging element module including a plurality of solid-state imaging devices identical in structure and arranged deviated at pixels thereby increasing an effective number of pixels, multi-plate solid-state imaging element module characterized in that: the plurality of solid-state imaging devices, after arranged deviated at pixels, are effectively arranged in a checkered form at all the pixels thereof.

In other words, the multi-plate solid-state imaging element module according to the present invention comprises a plurality of solid-state imaging devices identical in structure, each comprising a set of pixels, wherein said plurality of solid-state imaging devices are arranged so that the sets of pixels of said plurality of solid-state imaging devices are effectively deviated to each other, so as to effectively arrange all the pixels of the plurality of solid-state imaging devices in a checkered form.

In the multi-plate solid-state imaging element module in the invention, the set of pixels of each of the solid-state imaging devices may be arranged in a checkered form.

In the multi-plate solid-state imaging element module in the invention, the solid-state imaging devices may be four solid-state imaging devices.

An imaging apparatus according to the invention comprises: the above-mentioned multi-plate solid-state imaging element module; and an operation section that interpolates for data of an imaginary pixel in a position to fill between the pixels effectively arranged, from pixel data of the pixels effectively arranged around the relevant imaginary pixel.

### BRIEF DESCRIPTION OF THE DRAWINGS

FIG. 1 is a functional block diagram of a four-plate solid-state imaging apparatus according to an embodiment of the present invention;

FIG. 2 is a structural view of a four-plate solid-state imaging element module 22 shown in FIG. 1;

FIG. 3 is a graph showing a spectral characteristic of a color separation prism and trimming color filter for use on the four-plate solid-state imaging element module shown in FIG. 2;

FIG. 4 is a typical surface figure of a solid-state imaging device constituting the four-plate solid-state imaging element module shown in FIG. 2;

FIG. 5 is an arrangement figure of the real pixels on the four-plate solid-state imaging element module shown in FIG. 2;

FIGS. 6A to 6D are typical surface figures of a solid-state imaging device for use on the related-art four-plate solid-state imaging apparatus;

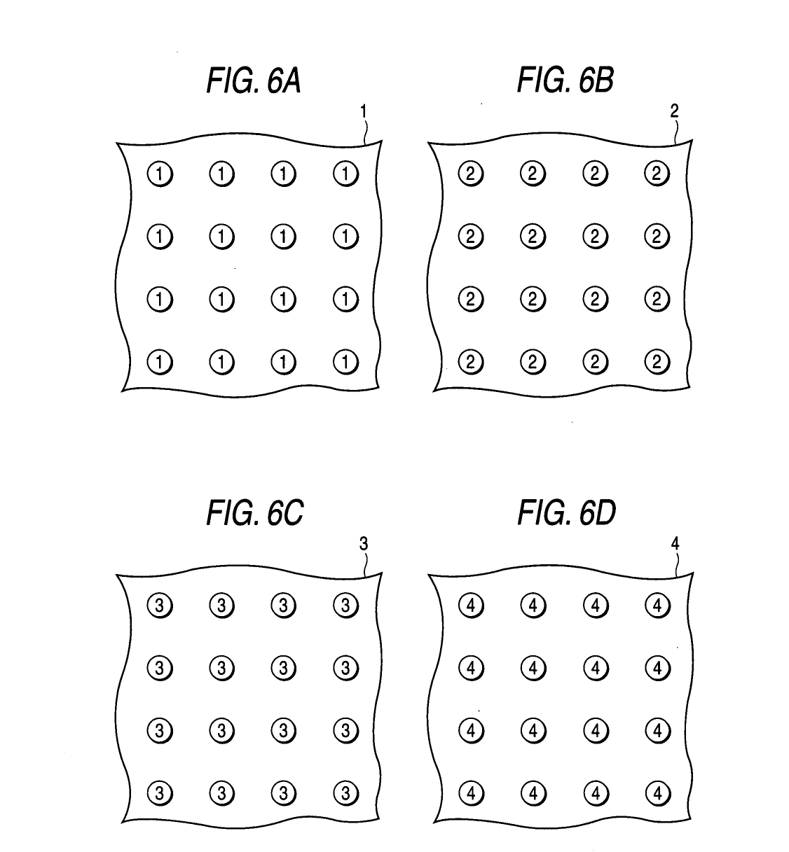

FIG. 7 is an arrangement figure of the real pixels where four solid-state imaging devices in a tetragonal lattice arrangement of pixels are arranged deviated at pixels thereby placing all the pixels in a tetragonal lattice arrangement; and

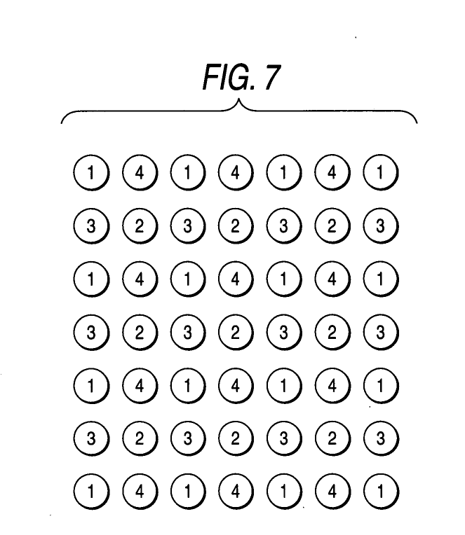

FIG. 8 is an arrangement figure of the real pixels where two solid-state imaging devices in a tetragonal lattice arrangement of pixels are arranged deviated at pixels thereby placing the pixels in a checkered arrangement.

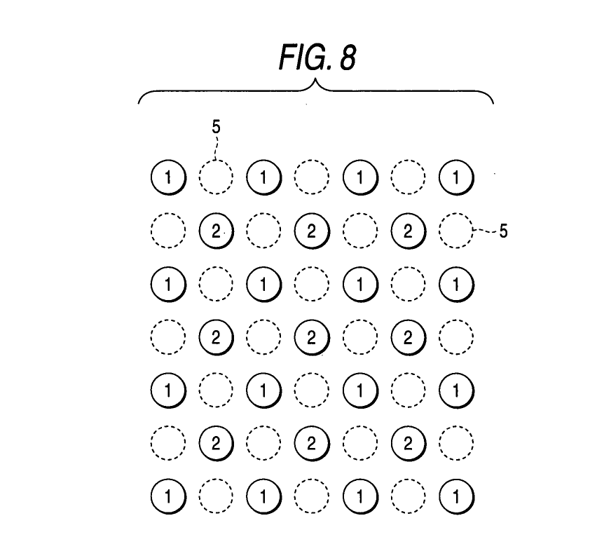

### DETAILED DESCRIPTION OF THE INVENTION

With reference to the drawings, an embodiment of the present invention will now be explained.

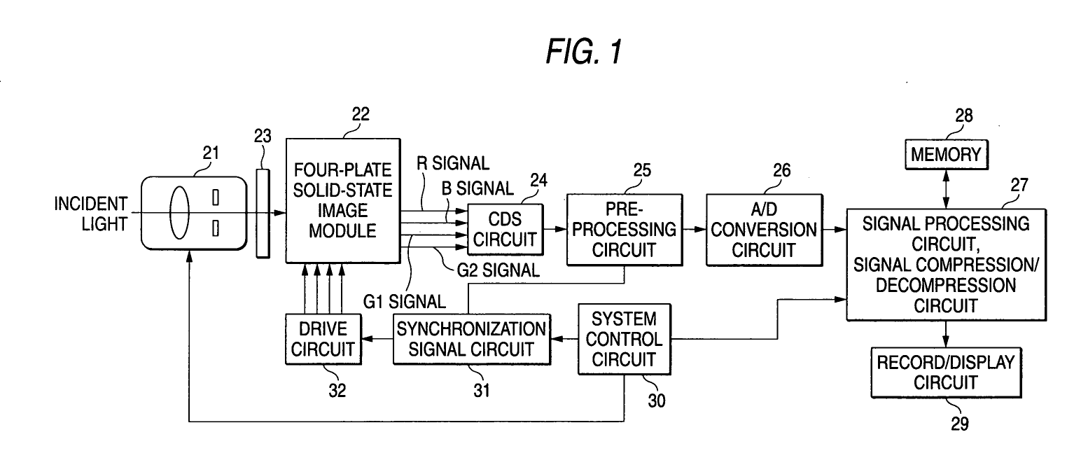

FIG. 1 is a block configuration diagram of a digital camera according to one embodiment of the present invention. The digital camera includes an optical system 21 mounting thereon a lens and restriction for focusing the light of from a subject, a four-plate solid-state imaging element module 22 according to the embodiment, and an infrared absorbing filter 23 arranged between the optical system 21 and the module 22.

The digital camera, in the embodiment, has also a CDS circuit 24 that fetches red (R), blue (B), first green (G1) and second green (G2) signals and performs a correlated-double sampling thereon, a pre-processing circuit 25 that fetches an output signal from the CDS circuit 24 and performs a gain-control processing thereon, an A/D conversion circuit 26 that converts the R, G1, G2 and B analog signals outputted from the pre-processing circuit 25 into digital signals, a circuit 27 that fetches the R, G1, G2 and B image signals outputted from the A/D conversion circuit 26 and performs a signal processing such as white-balance correction and gamma correction thereon and makes a signal compression/decompression processing of an photographic image, an image memory 28 connected to the circuit 27, and a record/display circuit 29 that records the photographic image data the circuit 27 processed in a not-shown external memory and displays it on a liquid-crystal display provided on a camera backside or the like.

The digital camera further has a system control circuit 30 that takes total control of the digital camera overall, a synchronization signal circuit 31 that generates a synchronization signal according to an instruction signal of from the system control circuit 30, and an imaging-device drive circuit 32 that outputs a drive signal to the solid-state imaging devices of the four-plate solid-state imaging element module 22 depending upon a synchronization signal.

In the digital camera of this embodiment, the optical system 21 is placed under control in its lens focusing and restriction depending upon an instruction signal of from the system control circuit 30. Through the optical system 21 and infrared absorbing filter 23, a subject optical image is focused on the four solid-state imaging devices of the module 22. In accordance with the optical image due to light reception, the solid-state imaging devices output red (R), first green (G1), second green (G2) and blue (B) signals. The pre-process circuit 25 takes gain control or so of the R, G1, G2 and B signals, according to the synchronization signal. The circuit 27 performs a signal processing, etc. depending upon the instruction from the system control circuit 30. Due to this, the photographic image is reproduced based upon the R, G1, G2 and B signals outputted from the solid-state imaging element module 22. The image data compressed in a JPEG form is recorded in the external memory.

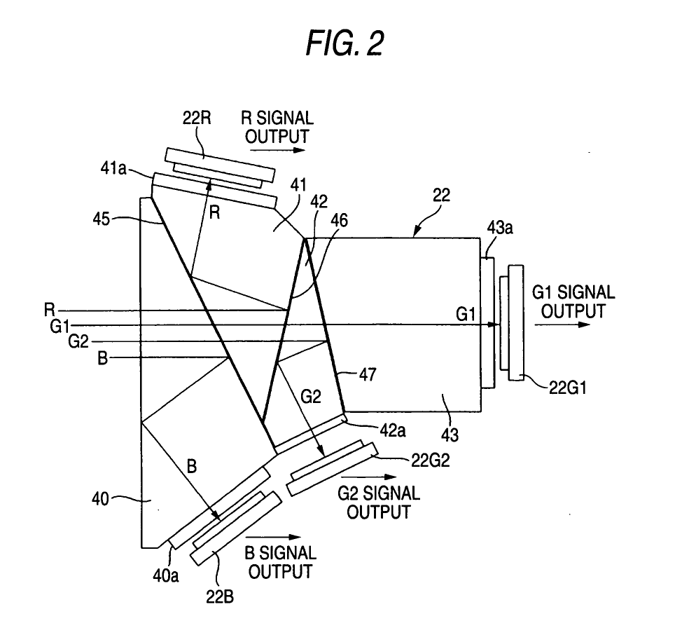

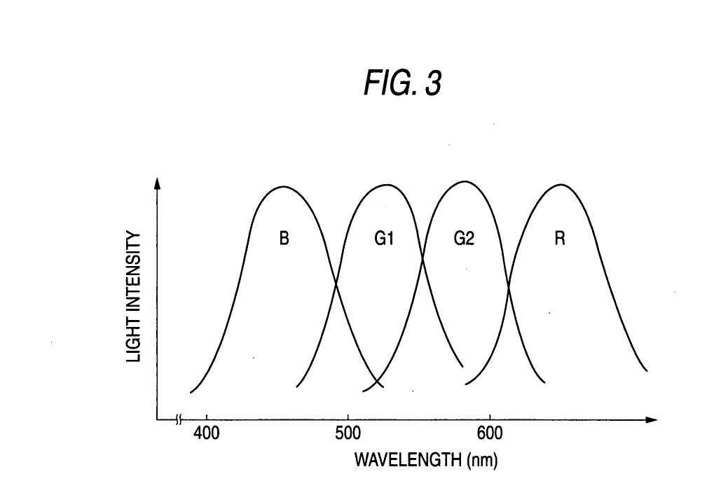

FIG. 2 is a structural view of the four-plate solid-state imaging element module 22. The module 22 has color separation prism that separates incident light into four parts, and four solid-state imaging devices 22R, 22G1, 22G2, 22B. FIG. 3 is a graph exemplifying a spectral characteristic of the blue (B), first green (G1), second green (G2) and red(R) portions of light which the color separation prism divided the incident light into four parts.

As shown in FIG. 2, the color separation prism has a first prism member 40, a second prism member 41, a third prism member 42, a fourth prism member 43, a blue(B)-light reflecting dichroic film 45 provided between the members 40 and 41, a red(R)-light reflecting dichroic film 46 provided between the members 41 and 42, and a second-green(G2)-light reflecting dichroic film 47 provided between the members 42 and 43.

The color separation prism also has a blue(B)-light trimming color filter 40a applied on a light-output surface of the first prism member 40, a red(R)-light trimming color filter 41a applied on a light-output surface of the second prism member 41, a second-green (G2)-light trimming color filter 42a applied on a light-output surface of the third prism member 42, and a first-green (G)-light trimming color filter 43a applied on a light-output surface of the fourth prism member 43.

The trimming color filter 40a, 41a, 42a, 43a serves for trimming in a manner such that the output light from the prism 40, 41, 42, 43 has a bell-shaped spectral characteristic, as shown in FIG. 3.

The solid-state imaging device 22B is arranged opposed at its light-receiving surface to the trimming color filter 40a. The solid-state imaging device 22R is arranged opposed at its light-receiving surface to the trimming color filter 41a. The solid-state imaging device 22G1 is arranged opposed at its light-receiving surface to the trimming color filter 42a. The solid-state imaging device 22G2 is arranged opposed at its light-receiving surface to the trimming color filter 43a.

In the case the light from a subject is incident upon the four-plate solid-state imaging element module 22 structured as above, the blue portion of the incident light reflects upon the dichroic film 45 and within the first prism 40, to enter the solid-state imaging device 22B. The red portion of the incident light reflects upon the dichroic film 46 and within the second prism 41, to enter the solid-state imaging device 22R. The G2 portion of the light reflects upon the dichroic film 47 and within the third prism 42, to enter the solid-state imaging device 22G2 while the G1 portion of the light travels straight in the fourth prism—member 43 and enters the solid-state imaging device 22G1, Design is made to provide an equal optical path length to between the light-incident surface of the first prism member 40 and the light-receiving surfaces of the solid-state imaging devices 22B, 22R, 22G1, 22G2.

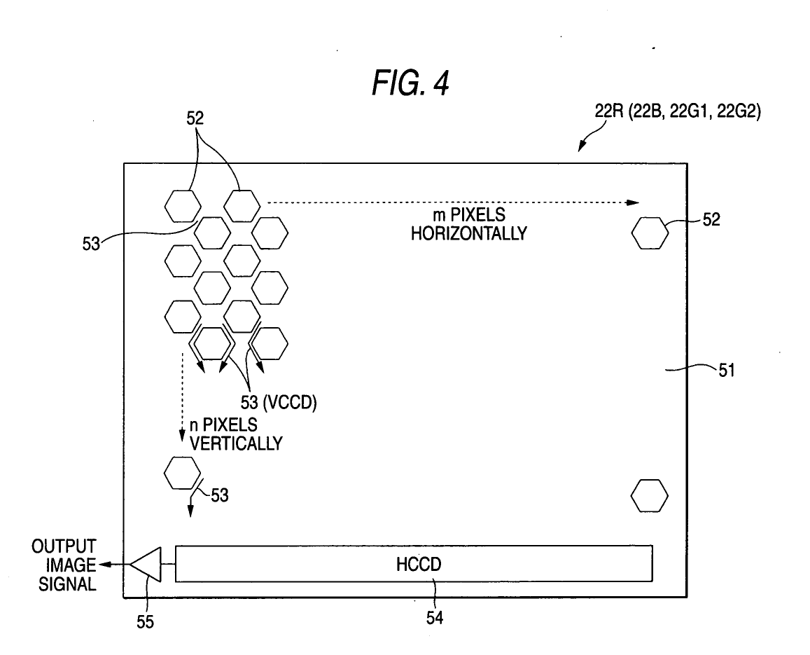

FIG. 4 is a typical surface view of the solid-state imaging device 22R (solid-state imaging devices 22B, 22G1, 22G2 structured similarly). The solid-state imaging device 22R has a multiplicity of photo-diodes 52 in a surface of a semiconductor substrate 51. The photo-diodes 52 are formed in a two-dimensional array arrangement, wherein the photo-diodes 52 on the odd row are formed deviated a half pitch relative to the photo-diodes 52 on the even row, i.e. honeycomb pixel arrangement (checkered arrangement).

Between the horizontally-adjacent ones of the photodiodes 52, vertical transfer lines (VCCDs) 53 are formed extending zigzag in the vertical direction. In the lower side region of the semiconductor substrate 51, a horizontal transfer line (HCCD) 54 is provided connected to the ends of the respective vertical transfer lines 53.

The signal charge, built up on the photo-diode 52 commensurate with the light received, is read out onto the adjacent vertical transfer line 53 and then transferred to the horizontal transfer line 54. Thee signal charge, transferred to the horizontal transfer line 54, is transferred along the horizontal transfer line 54 up to an output end thereof. An output amplifier 55 is provided at the output end of the horizontal transfer line, to output as image data a voltage signal dependent upon a signal charge amount.

Incidentally, although the terms “vertical” and “horizontal” are used, those simply mean respectively “one direction” and “direction nearly vertical to the one direction”. Although the solid-state imaging devices 22R, 22B, 22G1, 22G2 in the embodiment are of the CCD type, those may be MOS solid-state imaging devices where the pixels are in a checkered arrangement.

The four-plate solid-state imaging element module 22 in the embodiment uses four solid-state imaging devices 22R, 22B, 22G1, 22G2 that are same in structure, thus being arranged with deviation at pixels. Namely, relatively to the arrangement position of the solid-state imaging device 22R for detecting a red portion of light, the blue-light detecting solid-state imaging device 22B is arranged deviated a half pixel pitch in an x-direction (horizontally) or in a y-direction (vertically).

The G1-light detecting solid-state imaging device 22G1 is arranged deviated a half oblique pixel pitch in a 45-degree oblique right direction, relatively to the solid-state imaging device 22R. The G2-light detecting solid-state imaging device 22G2 is arranged deviated a half oblique pixel pitching a 45 degree oblique left direction relatively to the solid-state imaging device 22R.

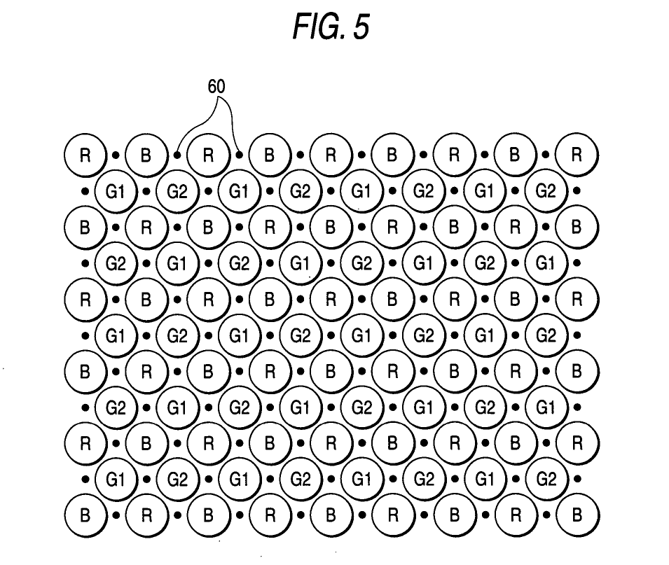

By thus arranging the four solid-state imaging devices, the solid-state imaging devices are effectively arranged as shown in FIG. 5. According to FIG. 5, provided that the pixels of the solid-state imaging devices 22R, 22B, 22G1, 22G2 (shown by circles in which described detecting portions of light R, B, G1, G2 respectively illustrating belonging to the solid-state imaging devices) are real pixels, the real pixels are effectively arranged in a checkered form.

When a subject is taken an image of by the digital camera that mounts a four-plate solid-state imaging element module 22 having such a structure, R, B, G1 and G2 signals are outputted from the real pixels of the four-plate solid-state imaging element module 22 to the FIG. 1 CDS circuit 24. The signals are outputted as digital image data from the A/D conversion circuit 26 to the signal processing circuit 27.

In the signal processing circuit 27, various image processes are performed including gamma correction, white balance correction and RGB/YC conversion. On this occasion, interpolation operating process is also done.

The image data, outputted from the real pixels of the four-plate solid-state imaging element module 22, provides a checkered form when arranged, as shown in FIG. 5. Where pixel data is merely in a checkered arrangement, there arises a need to place the image data in a tetragonal lattice arrangement because of the impossibility of of configuring an “image” that the pixel data is in a tetragonal lattice arrangement. Namely, image data is needed for an imaginary pixel 60 between the real pixels in the checkered arrangement.

For this reason, the signal processing circuit 27 produces data for the imaginary pixel 60 by an interpolation with the image data of the real pixels lying around the relevant imaginary pixel 60, and arranging it as data for the imaginary pixels 60.

Namely, in the embodiment, the four solid-state imaging devices are arranged deviated at pixels and the real pixels, after device arrangement, are placed in a checkered form. Accordingly, the number of real pixels is four times the number of the real pixels of one solid-state imaging device while the number of imaginary pixels 60 is obtainable in the same number, thus providing eight times the total number of pixels and hence eight times the resolution.

In this manner, for a multi-plate solid-state imaging apparatus, it is preferable to determine the pixel deviational position in a manner all the pixels are effectively arranged in a checkered form (honeycomb arrangement) after pixel deviational arrangement, in order to improve the resolution through increasing the number of effective number of pixels. Where using a solid-state imaging device in a honeycomb pixel arrangement, at least four solid-state imaging devices are needed.

Incidentally, the embodiment explained on the four-plate solid-state imaging apparatus for taking a color image, it is possible to structure a four-plate solid-state imaging apparatus for taking a black-and-white image instead of a color image. In such a case, it is satisfactory to use a beam splitter capable of splitting incident light into four portions, in place of the color separation prism and trimming color filter.

Meanwhile, the embodiment used the color separation prism and the trimming color filter. Alternatively, it is possible to use a solid-state imaging device using a beam splitter, for splitting incident light into four portions, in place of the color separation prism and trimming color filter and laying color filters on a pixel-by-pixel basis.

The embodiment was four-plate type. Alternatively, by using honeycomb-pixel-arranged solid-state imaging devices in the number of 4 to the power of n (e.g. sixteen), an imaging apparatus having a resolution higher than the number of solid-state imaging devices, similarly to the foregoing embodiment.

Meanwhile, the embodiment used four colors of R, G1, G2 and B. Alternatively, three colors of R, G and B may be used so that the G portion of light exiting the FIG. 2 prism member 41 can be divided by a beam splitter into two parts having the same spectral characteristic and allowed to enter two solid-state imaging devices separately.

According to the invention, because the pixels after a deviational arrangement of solid-state imaging devices are in a checkered arrangement, the data of an imaginary pixel position can be interpolated with the image data of the surrounding pixels thus improving the resolution.

The four-plate solid-state imaging apparatus according to the invention is allowed to obtain a resolution higher than the number of solid-state imaging devices, and hence useful if applied to a digital camera.

The entire disclosure of each and every foreign patent application from which the benefit of foreign priority has been claimed in the present application is incorporated herein by reference, as if fully set forth.

What is claimed is:

1. A multi-plate solid-state imaging element module comprising
a plurality of solid-state imaging devices identical in structure, each comprising a set of pixels,
wherein said plurality of solid-state imaging devices are arranged so that the sets of pixels of said plurality of solid-state imaging devices are effectively deviated to each other, so as to effectively arrange all the pixels of the plurality of solid-state imaging devices in a checkered form.

2. The multi-plate solid-state imaging element module according to claim 1,
wherein the set of pixels of each of the solid-state imaging devices are arranged in a checkered form.

3. The multi-plate solid-state imaging element module according to claim 2,
wherein said plurality of solid-state imaging devices are four solid-state imaging devices.

4. The multi-plate solid-state imaging element module according to claim 1, further comprising a color separation prism that separates incident light into a plurality of parts,
wherein said plurality of solid-state imaging devices are arranged in such a manner that said plurality of parts of light enter into said plurality of solid-state imaging devices, respectively.

5. The multi-plate solid-state imaging element module according to claim 4, further comprising a plurality of trimming color filters for trimming spectral characteristic of light by way of which said plurality of parts of light enter into said plurality of solid-state imaging devices, respectively.

6. The multi-plate solid-state imaging element module according to claim 4,
wherein the color separation prism separates the incident light into red light, green light and blue light.

7. An imaging apparatus comprising:
a multi-plate solid-state imaging element module according to claim 1; and
an operation section that interpolates for data of an imaginary pixel in a position to fill between the pixels effectively arranged, from pixel data of the pixels effectively arranged around the relevant imaginary pixel.
